(19) United States
(12) Patent Application Publication
(10) Pub. No.: US 2003/0081803 A1
(43) Pub. Date: May 1, 2003

(54) Low power, low noise, 3-level, H-bridge output coding for hearing aid applications

(76) Inventors: Eugene M. Petilli, Penfield, NY (US); James R. Hochschild, Plano, TX (US)

Correspondence Address: TEXAS INSTRUMENTS INCORPORATED, P O BOX 655474, M/S 3999, DALLAS, TX, 75265

(21) Appl. No.: 09/682,909

(22) Filed: Oct. 31, 2001

(51) Int. Cl. H04R 25/00

(52) U.S. Cl. 381/314; 381/312

(57) ABSTRACT

A hearing aid (5) has a ΣΔ delta modulator (26) that receives an input data stream (18) and produces a ΣΔ modulated output data stream, having three states {+1,0,−1}. An H-bridge (28) receives the ΣΔ modulated output data stream and produces an output signal for delivery to an associated acoustic transducer (24). A circuit (30) is provided between the ΣΔ modulator (26) and the H-bridge (28) to force the ΣΔ modulated data stream to return to a zero state as part of each non-zero output period in the ΣΔ modulated data stream. A differential oscillator (34) having a differential oscillator output signal clocks a differential latch (32) to provide a differentially latched output to the H-bridge (28).

### BACKGROUND OF INVENTION

1. Field of Invention

This invention relates to improvements in hearing aids of the type that use ΣΔ modulation and pulse stream handling processing, and more particularly to improvements in circuits and methods used therein, and still more particularly to improvements in circuits and methods for improving the power efficiency, linearity, and performance, and reducing the noise thereof.

2. Relevant Background

In the construction of hearing aids, one of the important circuit considerations is the amount of power that the hearing aid uses, since hearing aids are generally powered by relatively small batteries. To this end, it has been suggested to use sigma-delta (ΣΔ) modulation techniques in the hearing aid circuitry. However, in the past, only two level ΣΔ modulation techniques have been used. One of the disadvantages of such two level ΣΔ modulation techniques is the generation of a relatively large amount of quantization noise, which must be dealt with to avoid introducing distortion to the final acoustic signal.

In addressing the other problems that occur in such systems, the linearity and jitter noise become significant. To address these problems, much effort is directed to the design of the system clock to insure that it is as free of jitter as possible. In fact, a significantly large amount of design effort is often directed to the clock design with relation to the effort required of the remaining hearing aid circuitry.

What is needed, therefore, is an improved circuit and method for proving a ΣΔ modulation capability in a hearing aid environment in which power requirements and jitter and quantization noise can be reduced and linearity improved.

### SUMMARY OF INVENTION

In light of the above, therefore, it is an object of the invention to provide an improved hearing aid of the type having one or more digital signal processing circuits.

It is an advantage of the invention that the hearing aid presented has improved power efficiency.

It is another advantage of the invention that the hearing aid presented has reduced quantization noise.

It is yet another advantage of the invention that the hearing aid presented has reduced susceptibility to clock jitter and device mismatches.

It is still another advantage of the invention that the hearing aid presented has reduced susceptibility to imperfections in pulse shapes.

It is an advantage of the invention that the hearing aid presented has reduced signal noise and increased DAC linearity.

These and other objects, features and advantages of the invention will be to those skilled in the art from the following detailed description of the invention, when read in conjunction with the accompanying drawings and appended claims.

According to a broad aspect of the invention, a hearing aid is presented. The hearing aid has a sigma-delta modulator for receiving an input data stream and for producing a three-level sigma-delta modulated output data stream, preferably having data output bits selected from the set of bits including {+1,0,−1}. An H-bridge receives the sigma-delta modulated output data stream as an H-bridge input stream and produces an output signal for delivery to an associated acoustic transducer. The acoustic transducer may have a low pass frequency response sufficient to eliminate the need for an additional continuous time anti-alias filter. In one aspect, a circuit is provided between the sigma-delta modulator and the H-bridge for forcing the sigma-delta modulated data stream to return to a zero state as a part of each non-zero output period. In another aspect, a re-timing circuit is provided to re-time the output signal. The re-timing circuit may include a differential oscillator having a differential oscillator output signal and a differential latch to receive an output of the return-to-zero circuit, clocked by said differential oscillator output signal to provide a differentially latched output to the H-bridge.

According to another broad aspect of the invention, a method is presented for making a hearing aid. The method includes providing a sigma-delta modulator to receive an input data stream and to produce a three-level sigma-delta modulated output data stream, preferably having data output bits selected from the set of bits including {+1,0,−1}. The method also includes providing an H-bridge for receiving the sigma-delta modulated output data stream as an H-bridge input stream and providing a drive signal to an acoustic transducer. In one aspect, the method includes providing a circuit between the sigma-delta modulator and the H-bridge to force the sigma-delta modulated data stream to return to a zero state as a part of each non-zero output period. In another aspect, the method includes providing re-timing circuit to re-time the sigma-delta modulated data stream. The re-timing circuit may include a differential latch clocked by a differential oscillator output signal for receiving an output of the circuit for forcing the sigma-delta modulated data stream to return to a zero state to provide a differentially latched output to the H-bridge.

According to another broad aspect of the invention, a signal processing method for use in a hearing aid is presented. The method includes sigma-delta modulating an input data stream to produce a three-level sigma-delta modulated output data stream, preferably having data output bits selected from the set of bits including {+1,0,−1}. The modulated output data stream is then applied to an H-bridge for delivery to an acoustic transducer.

According to yet another broad aspect of the invention, a signal processing method for use in a hearing aid is presented. The method includes sigma-delta modulating a signal within the hearing aid to provide a sigma-delta modulated data stream. The sigma-delta modulated data stream is forced to return to a zero state as a part of each non-zero output period.

According to still another broad aspect of the invention, a signal processing method for use in a hearing aid is presented. The method includes sigma-delta modulating a signal within said hearing aid at a first frequency to produce a sigma-delta modulated output pulse stream. A re-timing circuit re-times the sigma-delta modulated output pulse stream at a second frequency, higher than said first frequency, to provide a differentially latched sigma-delta modulated output pulse stream. The re-timing circuit may include a differential latch.

### BRIEF DESCRIPTION OF DRAWINGS

The invention is illustrated in the accompanying drawings, in which:

FIG. 1 is a block diagram of a hearing aid, including a circuit having an improved DAC, according to a preferred embodiment of the invention.

FIG. 2 is a block diagram of a DAC circuit, according to a preferred embodiment of the invention, for use in the hearing aid circuit of FIG. 1.

FIG. 3 is a block diagram of a DAC circuit, according to a preferred embodiment of the invention, having additional noise reduction and linearity features, for use in the hearing aid circuit of FIG. 1.

FIG. 4A is a plot showing a prior art ΣΔ pulse stream waveform without a non-return to zero mode of operation.

And FIG. 4B is a plot showing a prior art ΣΔ pulse stream waveform without a return to zero mode of operation, according to a preferred embodiment of the invention.

In the various figures of the drawing, like reference numerals are used to denote like or similar parts.

### DETAILED DESCRIPTION

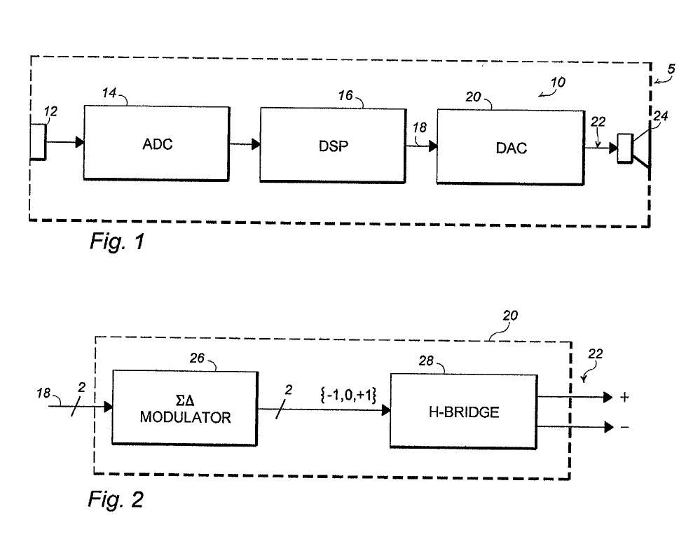

The invention is particularly useful in a hearing aid environment, as illustrated in FIG. 1, to which reference is first made. As shown, an electronic circuit 10, according to an embodiment of the invention, is embodied within a mechanical hearing aid enclosure 5, in a manner known in the art. The hearing aid enclosure 5 may be adapted, for example, to be emplaced near or in the ear canal of a user.

The circuit 10 includes a microphone 12, of well-known type, which transduces acoustic or sound waves to analog electrical signals. The analog electrical signals are converted to digital signals by an analog-to-digital (ADC) converter 14. The digital signals produced by the ADC 14 are then processed in a digital signal processor (DSP) 16. The processing may include, for example, filtering of some or all of the frequencies to be selectively amplified according to the individual needs of the user, applying noise reduction, and so on.

The digital output from the DSP 16 is applied on line 18 to a digital-to-analog converter (DAC) 20, which is constructed in accordance with the invention. The analog output from the DAC 20 is then applied via line 22 to a speaker 24, commonly referred to as a “receiver”, for creating an acoustic signal that has been modified by the circuit 10 for delivery to the user.

One embodiment of the DAC 20 that may be used is shown in FIG. 2, to which reference is now additionally made. The DAC 20 includes a sigma-delta (ΣΔ) modulator 26 that receives at its input the digital output signal from the DSP 16, which may be, for example, on two bit lines. The ΣΔ modulator 26 provides a ΣΔ modulated pulse stream to an H-bridge output circuit 14, which provides an electrical signal output on lines 22 for connection to the receiver 24.

According to one aspect of the invention, the ΣΔ modulator 26 provides a three-level pulse stream output. More particularly, the output states from the ΣΔ modulator 26 are preferably selected from the set {+1,0,−1} that includes three output levels. The three output levels may be, for example, encoded on two output bit lines to control the switches of the H-bridge 28. The H-bridge drives positive, negative or zero current pulses to the transducer in response to the {+1,0,−1} modulator outputs. It is understood that a zero current pulse can be generated by driving both H-bridge outputs to the same state: high, low or high-impedance. Although to the best of applicant's knowledge, ΣΔ modulators of the type that produce three level ΣΔ modulated data output streams have not been used in hearing aid applications, ΣΔ modulators of the type that produce three level ΣΔ modulated data output streams are well known, and are not described herein in detail.

One of the advantages realized by the circuit 20 is that the three-level output data stream enables quantization noise to be reduced, because the input signal is quantized to three output levels in contrast to two levels previously used. Linearity is preserved by the three-level output since the H-bridge is used to control only the polarity of the output signal and not its non-zero amplitude. Another of the advantages realized by this design is that the three-level output data stream enables power to be saved. Low power is especially important in hearing aid applications, and in this case power is reduced, since for small signals, many of the output samples are zero.

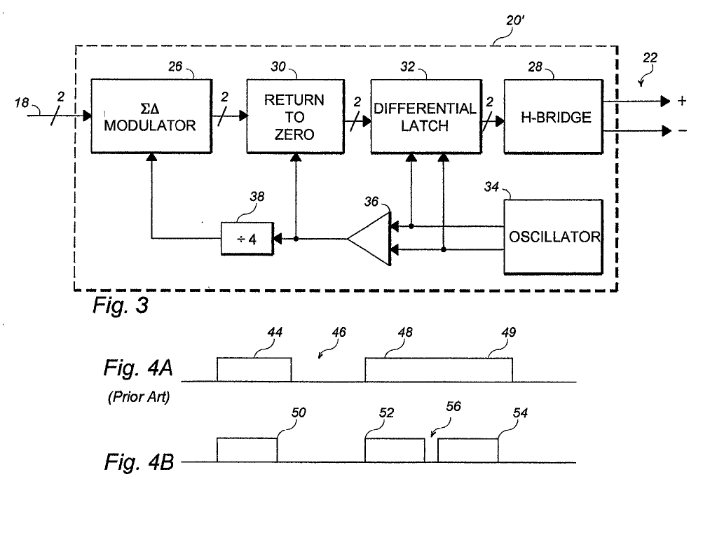

A modification of the design of the DAC 20 is shown in the circuit 20′ of FIG. 3 to which reference is now additionally made. The circuit 20′ receives the digital output signals from the DSP 16 on lines 18 and modulates them to produce a ΣΔ modulated pulse stream in a ΣΔ modulator 26. The frequency of the ΣΔ modulated pulse stream is controlled by an oscillator 34 having differential outputs that are delivered to a differential buffer 36, and divided by a divider circuit 38. The frequency of the oscillator may be, for example, on the order of 2.56 MHz. The frequency of the output pulse stream from the ΣΔ modulator 26 would therefore be on the order of about 640 KHz.

The output from the ΣΔ modulator 26 is then processed by a return-to-zero circuit 30. The return-to-zero circuit 30 operates to force adjacent pulses in the ΣΔ modulated pulse stream to return to a zero state as a part of each non-zero output period to avoid continuous same level pulses. More particularly, with reference to FIG. 4A, without a return-to-zero capability, pulse 48 and 49 following an initial pulse 44 and a zero section 46 appears to be continuous. However, for good noise linearity performance, it is important that the area of each non-zero output pulse be the same, independently of the adjacent pulses. Thus, the two adjacent +1 pulses 48 and 49 should have a total area of two times the area of a single isolated pulse. Unfortunately, adjacent pulses of the same non-zero level are missing the edges between the pulses. This means that the linearity requirement depends of the matching of the initial rising and final falling edges of the pulse. These edges are controlled by dissimilar devices in the H-bridge circuit (N-channel vs. P-channel MOS devices), so matching may be poor given process and temperature variations.

On the other hand, by virtue of the return-to-zero circuit 30 mitigates this effect.

The return-to-zero circuit 30 forces non-zero output pulses to return to a zero state for the last 25% of the sample period (with the frequency division illustrated by the divider 38). This results in the waveforms shown in FIG. 4B, where discrete pulses 50, 52, and 54 exist, with a definite break 56 of zero value between adjacent positive pulses 52 and 54. .

It should be noted that the return-to-zero circuit 30 does not require a three-state ΣΔ pulse stream of the type described above with regard to the circuit embodiment of FIG. 2. It can be equally advantageously used in conjunction with ΣΔ pulse streams of two or any number of data states, as well as in conjunction with the circuit 10 shown in FIG. 2.

After the signal is processed in the return-to-zero circuit 30, it is directed to a differential latch circuit 32, which reduces the effects of device mismatch and clock jitter in order to improve noise and linearity in the DAC. The differential latch circuit 32 is differentially clocked by differential clock outputs from the oscillator 34, as shown. As is known, another source of mismatch in the H-bridge output pulses is jitter on the pulse edges. This jitter can be caused by clock jitter or other sources of noise or mismatch in the digital circuits feeding the bridge. The differentially clocked latch circuit 32 before the bridge reduces this jitter, re-times the output pulse edges, and eliminates digital noise and mismatches errors. Since the latch circuit 32 is clocked with the lowest jitter clock available (the undivided differential output of the oscillator 34), pulse edge jitter due to clock jitter is minimized.

It again should be noted that the differential latch circuit 32 does not require a three-state ΣΔ pulse stream of the type described above with regard to the circuit embodiment of FIG. 2. It can be equally advantageously used in conjunction with ΣΔ pulse streams of two or any number of data states, as well as in conjunction with the circuit 10 shown in FIG. 2.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A hearing aid comprising:
a sigma-delta modulator for receiving an input data stream and for producing a three-level sigma-delta modulated output data stream;
an acoustic transducer;
and an H-bridge for receiving the sigma-delta modulated output data stream as an H-bridge input stream for producing an output signal for delivery to said acoustic transducer.

2. The hearing aid of claim 1 wherein said three-level sigma-delta modulated output data stream has data output bits selected from the set of bits including {+1,0,−1}.

3. The hearing aid of claim 1further comprising a circuit between said sigma-delta modulator and said H-bridge for forcing said sigma-delta modulated data stream to return to a zero state as part of each non-zero output period.

4. The hearing aid of claim 1further comprising:
a clock circuit for producing clock pulses;
and a circuit for re-timing the H-bridge input stream to said clock pulses.

5. The hearing aid of claim 4 wherein:
said clock circuit comprises a differential oscillator having a differential oscillator output signal to provide said clock pulses;
and said circuit for re-timing the output pulses comprises a differential latch clocked by said differential oscillator output signal for receiving an output of said circuit for forcing said sigma-delta modulated data stream to return to a zero state to provide a differentially latched output to said H-bridge.

6. A hearing aid comprising:
a sigma-delta modulator to modulate a signal within said hearing aid;
an H-bridge output circuit for delivering an output signal from said hearing aid to an acoustic transducer;
and a circuit between said sigma-delta modulator and said H-bridge for forcing said sigma-delta modulated data stream to return to a zero state as part of each non-zero output period.

7. The hearing aid of claim 6 wherein said sigma-delta modulator produces a three-level sigma-delta modulated output data stream having data output bits selected from the set of bits including {+1,0,−1}.

8. A hearing aid comprising:
a differential oscillator having a differential oscillator output signal;
a divider for dividing said differential oscillator output signal by a predetermined divisor to provide a divided differential oscillator output signal;
a sigma-delta modulator to modulate a signal within said hearing aid at a frequency of said divided differential oscillator output signal to produce a sigma-delta modulated output pulse stream;
an H-bridge output circuit for delivering an output signal from said hearing aid to an acoustic transducer;
and a pulse re-timing circuit clocked by said differential oscillator output signal for receiving said a sigma-delta modulated output pulse stream to provide a re-timed input stream to said H-bridge.

9. The hearing aid of claim 8 wherein said pulse re-timing circuit comprises a differential latch clocked by said differential oscillator output signal, for receiving said sigma-delta modulated output pulse stream to provide a differentially latched input stream to said H-bridge.

10. The hearing aid of claim 9 wherein said sigma-delta modulator produces a three-level sigma-delta modulated output data stream having data output bits selected from the set of bits including {+1,0,−1}.

11. A method for making a hearing aid comprising:
providing a sigma-delta modulator for receiving an input data stream and for producing a three-level sigma-delta modulated output data stream;
providing an acoustic transducer;
and providing an H-bridge for receiving the sigma-delta modulated output data stream for producing an output signal for delivery to said acoustic transducer.

12. The method of claim 11 further comprising providing said sigma-delta modulator with a capability to produce a three-level sigma-delta modulated output data stream having data output bits selected from the set of bits including {+1,0,−1}.

13. The method of claim 11 further comprising providing a circuit between said sigma-delta modulator and said H-bridge for forcing said sigma-delta modulated data stream to return to a zero state as part of each non-zero period.

14. The method of claim 13 further comprising:
providing a clock circuit for producing clock pulses;
and providing a re-timing circuit for re-timing pulses in said output signal.

15. The method of claim 14 wherein:
said providing a clock circuit comprises providing a differential oscillator having a differential oscillator output signal;
and providing a re-timing circuit comprises providing a differential latch clocked by said differential oscillator output signal for receiving an output of said circuit for forcing said sigma-delta modulated data stream to return to zero to provide a differentially latched input stream to said H-bridge.

16. A signal processing method for use in a hearing aid comprising:
sigma-delta modulating an input data stream to produce a three-level sigma-delta modulated output data stream;
and applying said modulated output data stream to an H-bridge for delivery to an acoustic transducer.

17. The signal processing method of claim 16 wherein said sigma-delta modulating an input data stream comprises sigma-delta modulating an input data stream to produce a data output stream having bits selected from the set of bits including {+1,0,−1}.

18. A signal processing method for use in a hearing aid comprising:
sigma-delta modulating a signal within said hearing aid to provide a sigma-delta modulated data stream;
and forcing said sigma-delta modulated data stream to return to a zero state as part of each non-zero output period.

19. The signal processing method of claim 18 wherein said sigma-delta modulating a signal comprises sigma-delta modulating said signal to produce a three-level sigma-delta modulated output data stream having data output bits selected from the set of bits including {+1,0,−1}.

20. A signal processing method for use in a hearing aid comprising:
sigma-delta modulating a signal within said hearing aid at a first frequency to produce a sigma-delta modulated output pulse stream;
and re-timing said sigma-delta modulated output pulse stream at a second frequency, higher than said first frequency, to provide a re-timed sigma-delta modulated input pulse stream to an H-bridge.

21. The signal processing method of claim 20 wherein said re-timing said sigma-delta modulated output pulse stream comprises differentially latching said sigma-delta modulated output pulse stream at said second frequency to provide a differentially latched sigma-delta modulated H-bridge input pulse stream.

22. The signal processing method of claim 21wherein said sigma-delta modulating comprises producing a three-level sigma-delta modulated output data stream having data output bits selected from the set of bits including {+1,0,−1}.

23. The signal processing method of claim 22 further comprising forcing said sigma-delta modulated data stream to return to a zero state as a part of each non-zero output period.

24. The signal processing method of claim 23 wherein each pulse of said differentially latched sigma-delta modulated H-bridge input pulse stream has substantially the same area.

25. The signal processing method of claim 21wherein said second frequency is four times larger than said first frequency.

26. The signal processing method of claim 25 wherein said second frequency is 2.56 MHz, and said first frequency is 640 KHz.
